(19) United States
(12) Patent Application Publication
(10) Pub. No.: US 2026/0299385 A1
(43) Pub. Date: Oct. 1, 2026

(54) MULTICOLOR LIGHT MIXING MODULE

(71) Applicant: QISDA CORPORATION, Taoyuan City (TW)

(72) Inventors: Ching-Tze Huang, Taoyuan City (TW); Kai-Jiun Wang, Taoyuan City (TW)

(73) Assignee: QISDA CORPORATION, Taoyuan City (TW)

(21) Appl. No.: 19/558,474

(22) Filed: Mar. 6, 2026

(30) Foreign Application Priority Data
Mar. 28, 2025 (CN) 202510381334.6

(51) Int. Cl. G03B 21/20

(52) U.S. Cl. CPC G03B 21/2013; G03B 21/2033; G03B 21/2066; G03B 21/208

(57) ABSTRACT

A multicolor light mixing module includes a light-mixing unit and a laser source including first lighting units, a second lighting unit and a third lighting unit arranged along an arrangement direction for emitting first, second and third color lights respectively in an emitting direction perpendicular to the arrangement direction. The light-mixing unit has a first dichroic surface reflecting the first color light and allowing the second and third color lights to pass through, a second dichroic surface allowing the third color light to pass through and reflecting the second color light to pass through the first dichroic surface, and a reflective surface sequentially arranged in parallel along a normal axis of the first dichroic surface. The reflective surface reflects the third color light to pass through the second and first dichroic surfaces, for mixing the first, second and third color lights along a light-mixing axis to form a multicolor beam.

### BACKGROUND OF THE INVENTION

### 1. Field of the Invention

The present invention relates to a multicolor light mixing module, and more specifically, to a multicolor light mixing module utilizing a light-mixing unit to perform single-axis light-mixing on a first color light, a second color light and a third color light respectively emitted from two first lighting units, a second lighting unit, and a third lighting unit sequentially arranged along an arrangement direction.

### 2. Description of the Prior Art

In general, a conventional laser projection apparatus adopts a light mixing module to provide a multicolor laser beam for subsequent image projection. In the practical application, for further reducing an overall volume of a laser source of the laser projection apparatus, the common design involves packaging red, green, and blue laser diodes in a side-by-side arrangement into one multicolor laser source module, so as to simultaneously provide red, green and blue color lights to the light mixing module of the laser projection apparatus.

However, since the aforesaid packaging design only arranges the red, green, and blue laser diodes in multiple rows sequentially (e.g., arranging a plurality of red laser diodes in a row and arranging a plurality of green and blue laser diodes in another row), it may cause a larger volume of the laser source and an uneven color distribution problem on an image projected by the laser projection apparatus (e.g., the image having a greenish upper portion and a bluish lower portion), so as to reduce the image projection quality of the laser projection apparatus and be disadvantageous to the miniaturization design of the laser projection apparatus.

### SUMMARY OF THE INVENTION

The present invention provides a multicolor light mixing module suitable for providing a multicolor laser beam to a laser projection device. The multicolor light mixing module includes a laser source and a light-mixing unit. The laser source includes at least two first lighting units, a second lighting unit, and a third lighting unit. The at least two first lighting units emits a first color light toward a light-emitting direction, the second lighting unit emits a second color light toward the light-emitting direction, and the third lighting unit emits a third color light toward the light-emitting direction, wherein the at least two first lighting units, the second lighting unit, and the third lighting unit are sequentially arranged along an arrangement direction, and the arrangement direction is perpendicular to the light-emitting direction. The light-mixing unit is disposed opposite to the laser source and has a first dichroic surface, a second dichroic surface, and a reflective surface. The first dichroic surface is oblique to reflect the first color light to travel along a light-mixing axis and to allow the second color light and the third color light to pass through and be incident onto the second dichroic surface, and the first dichroic surface, the second dichroic surface, and the reflective surface are sequentially arranged in parallel along a normal axis of the first dichroic surface. The second dichroic surface allows the third color light to pass through and be incident onto the reflective surface and reflects the second color light to pass through the first dichroic surface and travel along the light-mixing axis. The reflective surface reflects the third color light to sequentially pass through the second dichroic surface and the first dichroic surface and travel along the light-mixing axis, so that the first color light, the second color light, and the third color light are mixed along the light-mixing axis to form a multicolor laser beam.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a multicolor light mixing module according to one embodiment of the present invention.

FIG. 2 is a front view of the multicolor light mixing module in FIG. 1.

FIG. 3 is a diagram of a multicolor light mixing module according to another embodiment of the present invention.

FIG. 4 is a front view of the multicolor light mixing module in FIG. 3.

FIG. 5 is a diagram of a multicolor light mixing module according to another embodiment of the present invention.

FIG. 6 is a front view of the multicolor light mixing module in FIG. 5.

FIG. 7 is a diagram of a multicolor light mixing module according to another embodiment of the present invention.

FIG. 8 is a front view of the multicolor light mixing module in FIG. 7.

FIG. 9 is a diagram of a multicolor light mixing module according to another embodiment of the present invention.

FIG. 10 is a front view of the multicolor light mixing module in FIG. 9.

### DETAILED DESCRIPTION

The present invention will now be described more specifically with reference to the following embodiments and the accompanying drawings. Other advantages and effects of the present invention can be easily understood by a person ordinarily skilled in the art in view of the detailed descriptions and the accompanying drawings. The present invention can be implemented or applied to other different embodiments. Certain aspects of the present invention are not limited by the particular details of the examples illustrated herein. Without departing from the spirit and scope of the present invention, the present invention will have other modifications and changes. It should be understood that the appended drawings are not necessarily drawn to the scale and configuration of each component (e.g., structural sizes and configuration of lighting unit/light-mixing unit/circuit board) in the drawings is merely illustrative, not presenting an actual condition of the embodiments.

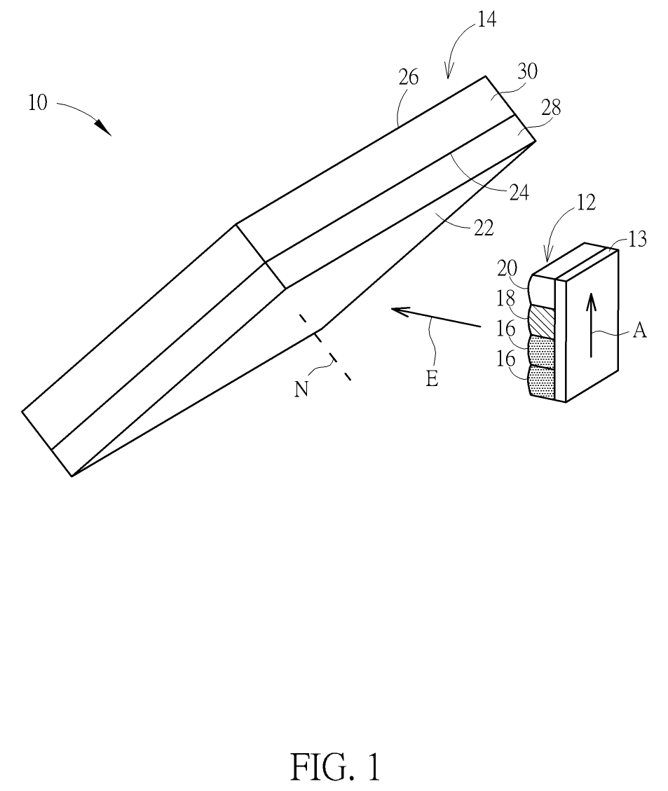

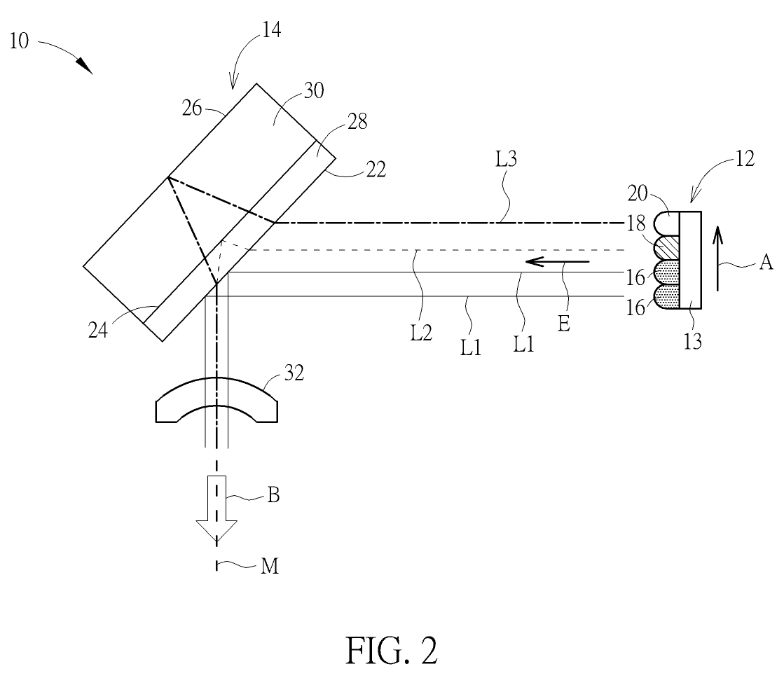

Please refer to FIGS. 1 and 2. FIG. 1 is a diagram of a multicolor light mixing module 10 according to one embodiment of the present invention. FIG. 2 is a front view of the multicolor light mixing module 10 in FIG. 1. As shown in FIGS. 1 and 2, the multicolor light mixing module 10 is utilized to provide a multicolor laser beam to a laser projection device for subsequent projection imaging. The multicolor light mixing module 10 includes a laser source 12 and a light-mixing unit 14.

The laser source 12 includes at least two first lighting units 16, a second lighting unit 18, and a third lighting unit 20. The two first lighting units 16, the second lighting unit 18, and the third lighting unit 20 could be disposed on a circuit board 13 adopting a single-board configuration (the related description for light-emitting control and circuit configuration of the circuit board 13 is commonly seen in the prior art and omitted herein) and sequentially arranged along an arrangement direction A, and the arrangement direction A is perpendicular to an emitting direction E of the first lighting unit 16, the second lighting unit 18, and the third lighting unit 20. The first lighting unit 16 could be preferably a red laser diode for emitting a first color light L1 (i.e., red light). The second lighting unit 18 could be preferably a green laser diode for emitting a second color light L2 (i.e., green light). The third lighting unit 20 could be preferably a blue laser diode for emitting a third color light L3 (i.e., blue light). The present invention is not limited to the aforesaid design, meaning that the color light configuration and the type of light source could be varied with the practical application of the multicolor light mixing module 10.

The light-mixing unit 14 is disposed at a position opposite to the laser source 12 and has a first dichroic surface 22, a second dichroic surface 24, and a reflective surface 26. The first dichroic surface 22, the second dichroic surface 24, and the reflective surface 26 are sequentially arranged in parallel along a normal axis N of the first dichroic surface 22. The first dichroic surface 22 is disposed obliquely for reflecting the first color light L1 to travel along a light-mixing axis M and allowing the second color light L2 and the third color light L3 to pass through and be incident onto the second dichroic surface 24. The second dichroic surface 24 allows the third color light L3 to pass through and be incident onto the reflective surface 26. The second dichroic surface 24 reflects the second color light L2 to pass through the first dichroic surface 22 and then travel along the light-mixing axis M. The reflective surface 26 reflects the third color light L3 to sequentially pass through the second dichroic surface 24 and the first dichroic surface 22 and then travel along the light-mixing axis M.

To be more specific, in this embodiment, the light-mixing unit 14 includes a dichroic mirror 28 and a reflective mirror 30. The dichroic mirror 28 is disposed obliquely opposite to the laser source 12 (the inclination angle of the dichroic mirror 28 could be preferably equal to 45°, but not limited thereto). The first dichroic surface 22 is formed at a light-entrance surface position of the dichroic mirror 28. The dichroic mirror 28 and the reflective mirror 30 could be stacked and connected along the normal axis N of the first dichroic surface 22. The second dichroic surface 24 is formed at a position where the reflective mirror 30 is connected to the dichroic mirror 28 (for example, the second dichroic surface 24 could be respectively formed at a back surface position of the dichroic mirror 28 and a light-entrance surface position of the reflective mirror 30, but not limited thereto). The reflective surface 26 is formed at a back surface position of the reflective mirror 30. Accordingly, the first dichroic surface 22 can reflect the first color light L1 to travel along the light-mixing axis M and allow the second color light L2 and the third color light L3 to pass through and be incident onto the second dichroic surface 24. The second dichroic surface 24 can reflect the second color light L2 to travel along the light-mixing axis M and allow the third color light L3 to pass through and be incident onto the reflective surface 26. The reflective surface 26 can reflect the third color light L3 to sequentially pass through the second dichroic surface 24 and the first dichroic surface 22 and then travel along the light-mixing axis M. As shown in FIG. 2, an optical path distance of the first color light L1 incident to the first dichroic surface 22 is smaller than an optical path distance of the second color light L2 passing through the first dichroic surface 22, being reflected by the second dichroic surface 24, and then be emitted from the first dichroic surface 22. Furthermore, the aforesaid optical path distance of the second color light L2 is smaller than an optical path distance of the third color light L3 sequentially passing through the first dichroic surface 22 and the second dichroic surface 24, being reflected by the reflective surface 26 to pass through the second dichroic surface 24, and then being emitted from the first dichroic surface 22.

In such a manner, via the aforementioned light guiding design, the light-mixing unit 14 can guide the first color light L1, the second color light L2, and the third color light L3 to respectively travel along the light-mixing axis M to form a multicolor laser beam B (as shown in FIG. 2), so as to achieve a single-axis light-mixing effect for providing the multicolor laser beam to the laser projection apparatus for subsequent projection imaging. In addition, as shown in FIG. 2, the first color light L1 is located on both sides of the second color light L2 and the third color light L3, and travels together with the second color light L2 and the third color light L3 along the light-mixing axis M, thereby achieving the symmetric and uniform light-mixing effect.

To be noted, as shown in FIG. 2, the multicolor light mixing module 10 could further include at least one condensing lens 32 (one shown in FIG. 2, but not limited thereto, meaning that the configuration and quantity of lenses depend on the actual manufacturing application requirements of the multicolor light mixing module 10). The condensing lens 32 (e.g., a convex lens, a cylindrical lens, or any lens combination thereof) is disposed on the light-mixing axis M for condensing the first color light L1, the second color light L2, and the third color light L3.

Compared with the prior art adopting the packaging configuration in which the red, green, and blue laser diodes are arranged in multiple rows sequentially (e.g., arranging a plurality of red laser diodes in a row and arranging a plurality of green and blue laser diodes in another row), via the aforementioned design that the light-mixing unit is utilized to perform single-axis light mixing on the first color light, the second color light, and the third color light respectively emitted from the two first lighting units, the second lighting unit, and the third lighting unit sequentially arranged along the arrangement direction, the present invention can achieve the single-axis light-mixing effect and provide the laser beam with multicolor light distributed in proper proportions. In such a manner, the present invention can efficiently solve the uneven color distribution problem on the image projected by the laser projection apparatus (e.g., the image having a greenish upper portion and a bluish lower portion) and the problem that the volume of the laser source is larger aforementioned in the prior art, so as to greatly improve the image projection quality and color uniformity of the laser projection apparatus and be advantageous to the miniaturization design of the laser projection apparatus.

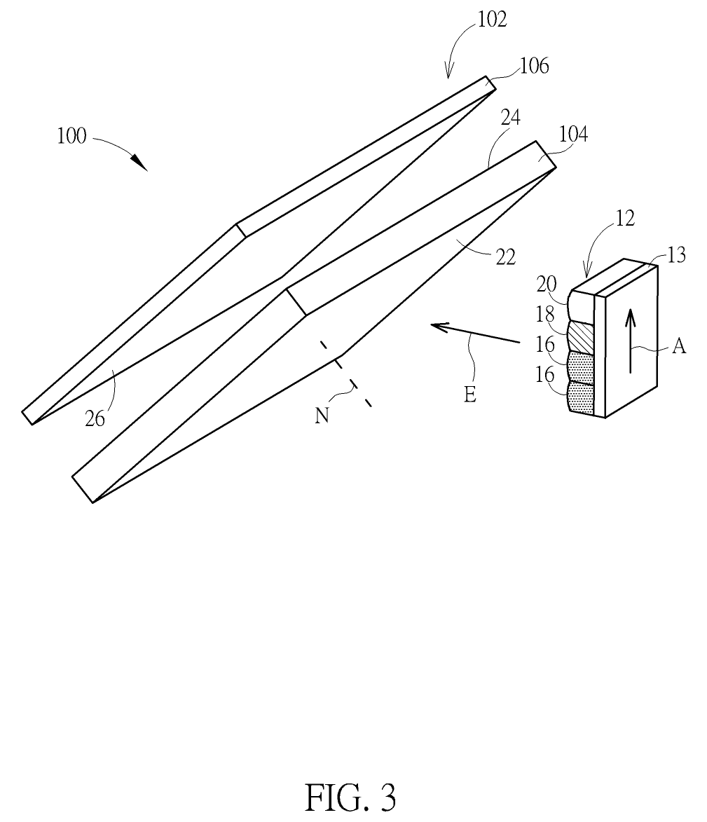

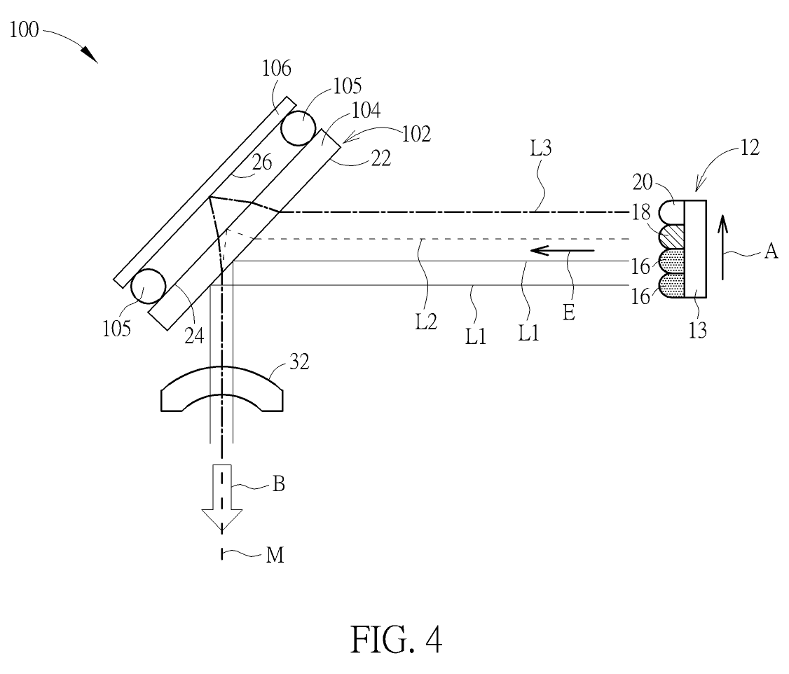

It should be mentioned that the light-mixing unit of the present invention is not limited to the stacked dichroic reflective mirror design, which means the present invention could adopt a design in which the dichroic mirror and the reflective mirror are spaced apart from each other. For example, please refer to FIGS. 3 and 4. FIG. 3 is a diagram of a multicolor light mixing module 100 according to another embodiment of the present invention. FIG. 4 is a front view of the multicolor light mixing module 100 in FIG. 3. Components both mentioned in this embodiment and the aforesaid embodiments represent components with similar structures or functions, and the related description could be reasoned by analogy according to the aforesaid embodiments and omitted herein. As shown in FIGS. 3 and 4, the multicolor light mixing module 100 includes the laser source 12 and a light-mixing unit 102. In this embodiment, the light-mixing unit 102 includes a dichroic mirror 104 and a reflective mirror 106, and has the first dichroic surface 22, the second dichroic surface 24, and the reflective surface 26. The dichroic mirror 104 and the reflective mirror 106 are disposed obliquely opposite to the laser source 12 (the inclination angles of the dichroic mirror 104 and the reflective mirror 106 could be preferably equal to 45°, but not limited thereto). The first dichroic surface 22 is formed at a light-entrance surface position of the dichroic mirror 104 to reflect the first color light L1 and allow the second color light L2 and the third color light L3 to pass through. The second dichroic surface 24 is formed at a back surface position of the dichroic mirror 104 to reflect the second color light L2 and allow the third color light L3 to pass through. The dichroic mirror 104 and the reflective mirror 106 are spaced apart from each other along the normal axis N of the first dichroic surface 22 (for example, a spacer 105 in FIG. 4 could be utilized to separate the dichroic mirror 104 from the reflective mirror 106, but not limited thereto). The reflective surface 26 is formed at a light-entrance surface position of the reflective mirror 106 to reflect the third color light L3 to sequentially pass through the second dichroic surface 24 and the first dichroic surface 22 and then travel along the light-mixing axis M.

In such a manner, via the aforementioned spaced light guiding design and by properly controlling a structural thickness of the dichroic mirror 104 and an air spacing distance between the dichroic mirror 104 and the reflective mirror 106, the light-mixing unit 102 can guide the first color light L1, the second color light L2, and the third color light L3 to travel along the light-mixing axis M to form the multicolor laser beam B (as shown in FIG. 4), so as to achieve the single-axis light-mixing effect and provide the multicolor laser beam to the laser projection apparatus for subsequent projection imaging. In addition, as shown in FIG. 4, the first color light L1 is located on both sides of the second color light L2 and the third color light L3, and travels together with the second color light L2 and the third color light L3 along the light-mixing axis M, thereby achieving a symmetric and uniform light-mixing effect.

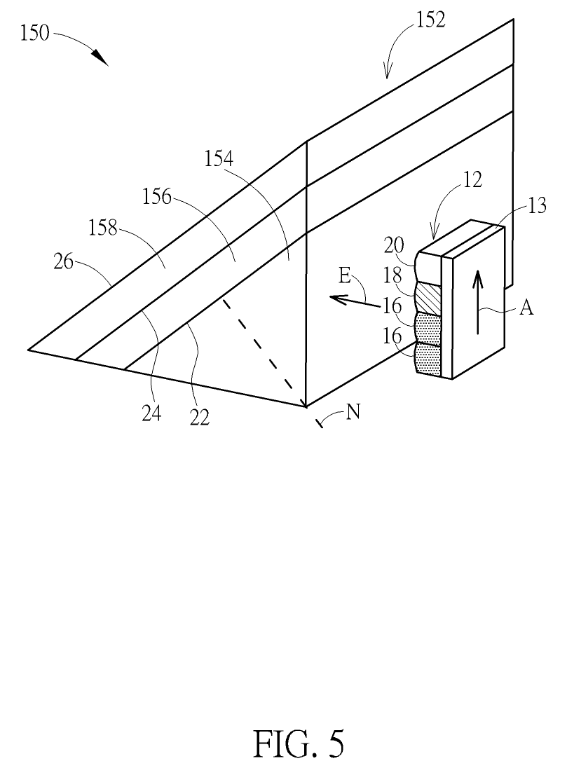

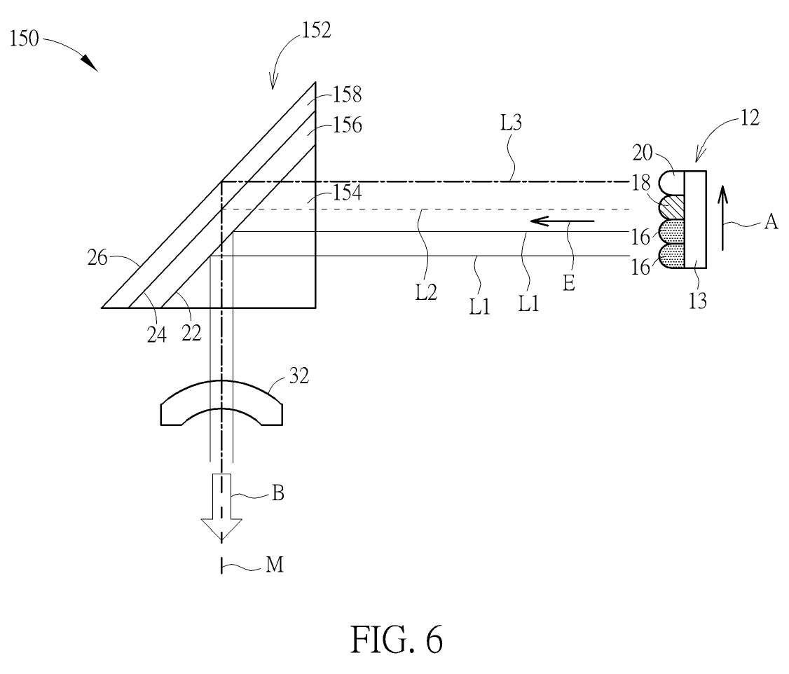

Moreover, the light-mixing unit of the present invention could adopt a triangular prism column design. For example, please refer to FIGS. 5 and 6. FIG. 5 is a diagram of a multicolor light mixing module 150 according to another embodiment of the present invention. FIG. 6 is a front view of the multicolor light mixing module 150 in FIG. 5. Components both mentioned in this embodiment and the aforesaid embodiments represent components with similar structures or functions, and the related description could be reasoned by analogy according to the aforesaid embodiments and omitted herein. As shown in FIGS. 5 and 6, the multicolor light mixing module 150 includes the laser source 12 and a light-mixing unit 152. In this embodiment, the light-mixing unit 152 includes a bottom corner prism 154, a middle prism 156, and a top edge prism 158, and has the first dichroic surface 22, the second dichroic surface 24, and the reflective surface 26. The bottom corner prism 154 has the first dichroic surface 22 to allow the second color light L2 and the third color light L3 to pass through and to reflect the first color light L1 to travel along the light-mixing axis M. The bottom corner prism 154, the middle prism 156, and the top edge prism 158 are sequentially spliced along the normal axis N of the first dichroic surface 22, so as to cooperatively form a triangular prism column disposed opposite to the laser source 12. The middle prism 156 has the second dichroic surface 24 to allow the third color light L3 to pass through and to reflect the second color light L2 to pass through the first dichroic surface 22 and then travel along the light-mixing axis M. The top edge prism 158 has the reflective surface 26 to reflect the third color light L3 to sequentially pass through the second dichroic surface 24 and the first dichroic surface 22 and then travel along the light-mixing axis M.

In such a manner, via the aforementioned triangular prism column design and by properly controlling structural thicknesses of the bottom corner prism 154, the middle prism 156, and the top edge prism 158, the light-mixing unit 152 can guide the first color light L1, the second color light L2, and the third color light L3 to travel along the light-mixing axis M to form the multicolor laser beam B (as shown in FIG. 6), so as to achieve the single-axis light-mixing effect and provide the multicolor laser beam to the laser projection apparatus for subsequent projection imaging. In addition, as shown in FIG. 6, the first color light L1 is located on both sides of the second color light L2 and the third color light L3, and travels together with the second color light L2 and the third color light L3 along the light-mixing axis M, thereby achieving a symmetric and uniform light-mixing effect.

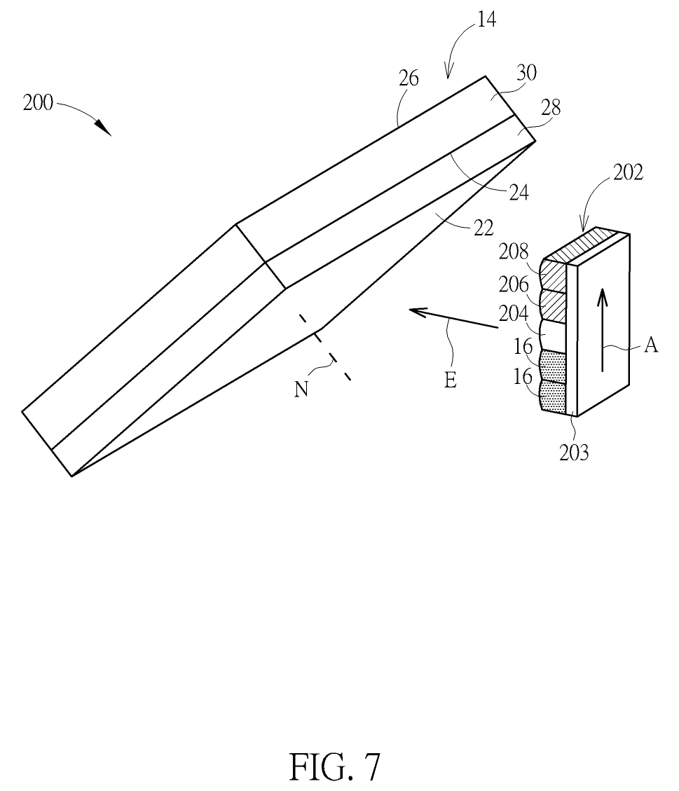

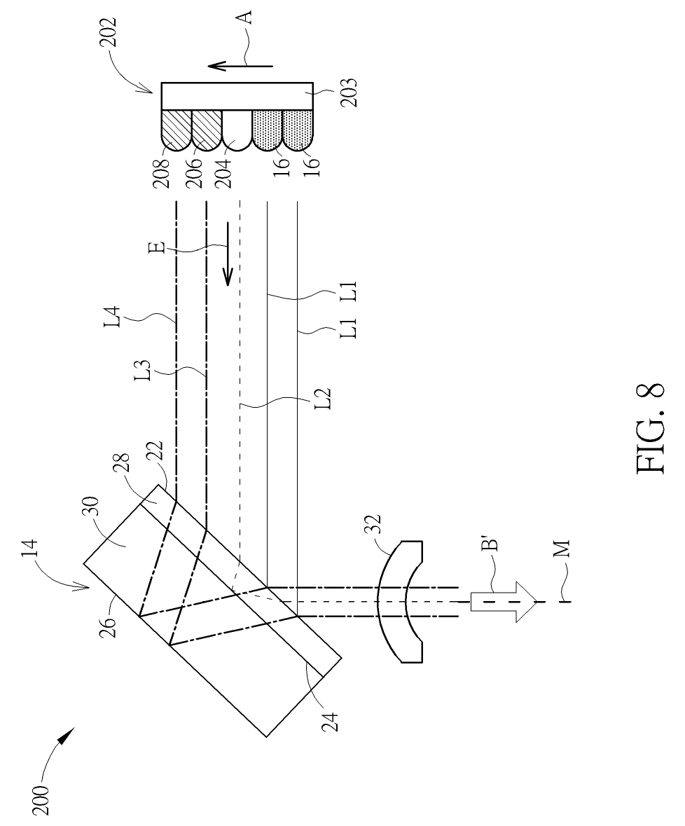

In practical applications, the present invention could adopt five lighting units. Please refer to FIGS. 7 and 8. FIG. 7 is a diagram of a multicolor light mixing module 200 according to another embodiment of the present invention. FIG. 8 is a front view of the multicolor light mixing module 200 in FIG. 7. Components both mentioned in this embodiment and the aforesaid embodiments represent components with similar structures or functions, and the related description could be reasoned by analogy according to the aforesaid embodiments and omitted herein. As shown in FIGS. 7 and 8, the multicolor light mixing module 200 includes a laser source 202 and the light-mixing unit 14. The laser source 202 includes at least two first lighting units 16, a second lighting unit 204, a third lighting unit 206, and a fourth lighting unit 208. The two first lighting units 16, the second lighting unit 204, the third lighting unit 206, and the fourth lighting unit 208 could be disposed on a circuit board 203 adopting a single-board configuration (the related description for light-emitting control and circuit configuration of the circuit board 203 is commonly seen in the prior art and omitted herein) and sequentially arranged along the arrangement direction A, and the arrangement direction A is perpendicular to the emitting direction E of the first lighting unit 16, the second lighting unit 204, the third lighting unit 206, and the fourth lighting unit 208. The first lighting unit 16 could be preferably a red laser diode for emitting the first color light L1 (i.e., red light). The second lighting unit 204 could be preferably a green laser diode for emitting the second color light L2 (i.e., green light). The third lighting unit 206 could be preferably a blue laser diode for emitting the third color light L3 (i.e., blue light). The fourth lighting unit 208 could be preferably a green laser diode for emitting a fourth color light L4 (i.e., green light with the same wavelength as the third color light L3). The present invention is not limited to the aforesaid design, meaning that the color light configuration and the type of light source could be varied with the practical application of the multicolor light mixing module 200.

Via the above-mentioned design, the first dichroic surface 22 can reflect the first color light L1 to travel along the light-mixing axis M and allow the second color light L2, the third color light L3, and the fourth color light L4 to pass through and be incident onto the second dichroic surface 24. The second dichroic surface 24 can reflect the second color light L2 to travel along the light-mixing axis M and allow the third color light L3 and the fourth color light L4 to pass through and be incident onto the reflective surface 26. The reflective surface 26 can reflect the third color light L3 and the fourth color light L4 to sequentially pass through the second dichroic surface 24 and the first dichroic surface 22 and then travel along the light-mixing axis M. As shown in FIG. 8, the optical path distance of the first color light L1 incident on the first dichroic surface 22 is shorter than the optical path distance of the second color light L2 passing through the first dichroic surface 22, being reflected by the second dichroic surface 24, and then being emitted from the first dichroic surface 22. The aforesaid optical path distance of the second color light L2 is shorter than the optical path distance of the third color light L3 and the fourth color light L4 sequentially passing through the first dichroic surface 22 and the second dichroic surface 24, being reflected by the reflective surface 26 to pass through the second dichroic surface 24, and then being emitted from the first dichroic surface 22.

In such a manner, via the aforementioned light guiding design, the light-mixing unit 14 can guide the first color light L1, the second color light L2, the third color light L3 and the fourth color light L4 to travel along the light-mixing axis M to form a multicolor laser beam B’ (as shown in FIG. 8), so as to achieve the single-axis light-mixing effect and provide the multicolor laser beam to the laser projection apparatus for subsequent projection imaging. In addition, as shown in FIG. 8, the first color light L1 is mixed with the third color light L3 and the fourth color light L4 to be located on both sides of the second color light L2, and travels together with the second color light L2, the third color light L3 and the fourth color light L4 along the light-mixing axis M, thereby achieving a symmetric and uniform light-mixing effect. The aforesaid configuration of the five lighting units could also be selectively applied to the light-mixing unit 102 adopting the design in which the dichroic mirror and the reflective mirror are spaced apart from each other, and the related description could be reasoned by analogy according to the aforesaid embodiments and omitted herein.

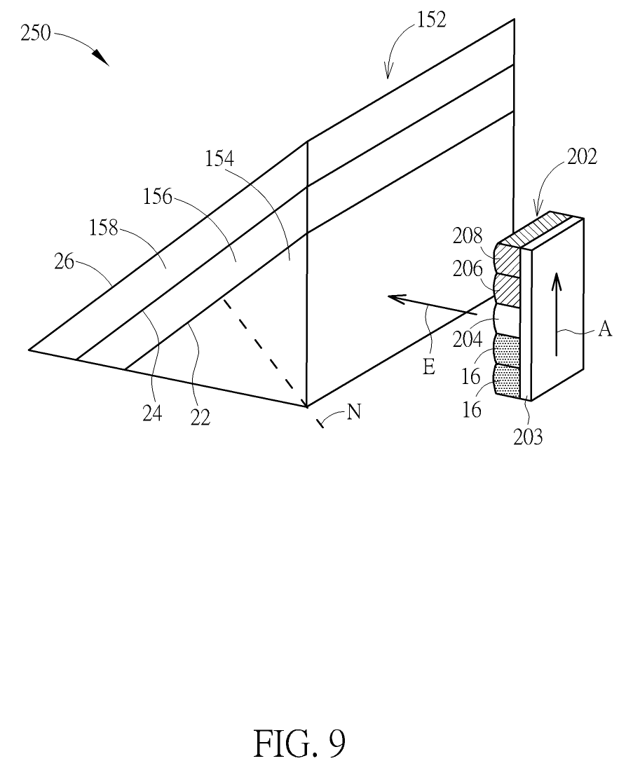

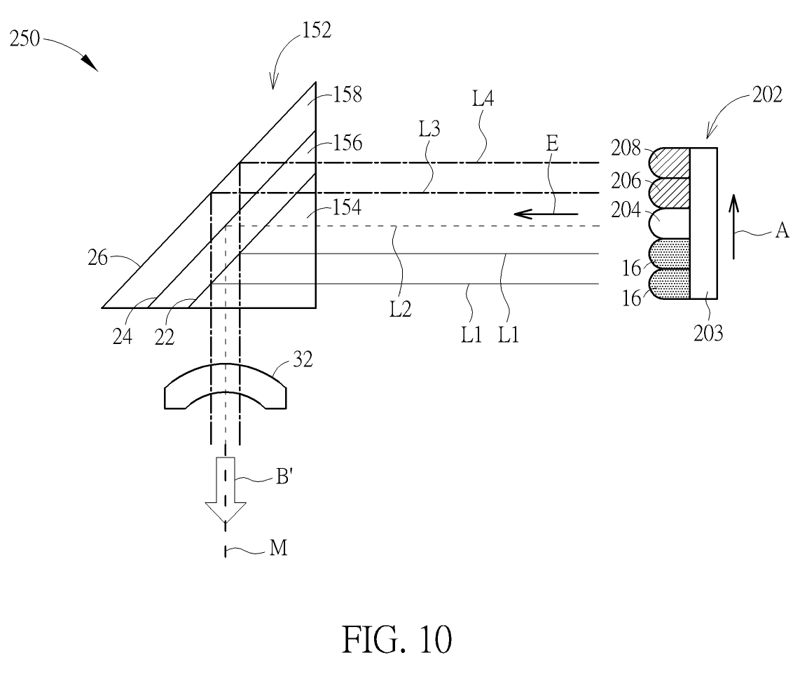

The aforesaid configuration of the five lighting units could also be selectively applied to the light-mixing unit 152 adopting the triangular prism column design. For example, please refer to FIGS. 9 and 10. FIG. 9 is a diagram of a multicolor light mixing module 250 according to another embodiment of the present invention. FIG. 10 is a front view of the multicolor light mixing module 250 in FIG. 9. Components both mentioned in this embodiment and the aforesaid embodiments represent components with similar structures or functions, and the related description could be reasoned by analogy according to the aforesaid embodiments and omitted herein. As shown in FIGS. 9 and 10, the multicolor light mixing module 250 includes the laser source 202 and the light-mixing unit 152. In this embodiment, the laser source 202 includes at least two first lighting units 16, the second lighting unit 204, the third lighting unit 206, and the fourth lighting unit 208. The light-mixing unit 152 includes the bottom corner prism 154, the middle prism 156, and the top edge prism 158, and has the first dichroic surface 22, the second dichroic surface 24, and the reflective surface 26. The bottom corner prism 154, the middle prism 156, and the top edge prism 158 are sequentially spliced along the normal axis N of the first dichroic surface 22 to cooperatively form a triangular prism column opposite to the laser source 202.

The bottom corner prism 154 has the first dichroic surface 22 for reflecting the first color light L1 to travel along the light-mixing axis M and for allowing the second color light L2, the third color light L3, and the fourth color light L4 to pass through and be incident onto the second dichroic surface 24. The middle prism 156 has the second dichroic surface 24 for reflecting the second color light L2 to travel along the light-mixing axis M and for allowing the third color light L3 and the fourth color light L4 to pass through and be incident onto the reflective surface 26. The top edge prism 158 has the reflective surface 26 for reflecting the third color light L3 and the fourth color light L4 to sequentially pass through the second dichroic surface 24 and the first dichroic surface 22 and then travel along the light-mixing axis M. As shown in FIG. 10, the optical path distance of the first color light L1 incident on the first dichroic surface 22 is shorter than the optical path distance of the second color light L2 passing through the first dichroic surface 22, being reflected by the second dichroic surface 24, and then being emitted from the first dichroic surface 22. The aforesaid optical path distance of the second color light L2 is shorter than the optical path distance of the third color light L3 and the fourth color light L4 sequentially passing through the first dichroic surface 22 and the second dichroic surface 24, being reflected by the reflective surface 26 to pass through the second dichroic surface 24, and then being emitted from the first dichroic surface 22.

Thus, via the aforesaid triangular prism column design and by properly controlling the structural thicknesses of the bottom corner prism 154, the middle prism 156, and the top edge prism 158, the light-mixing unit 152 can guide the first color light L1, the second color light L2, the third color light L3, and the fourth color light L4 of the laser source 202 to travel respectively along the light-mixing axis M for forming the multicolor laser beam B′ (as shown in FIG. 10), thereby achieving the single-axis light-mixing effect and providing the multicolor laser beam to the laser projection apparatus for subsequent projection imaging. In addition, as shown in FIG. 10, the first color light L1 can respectively be mixed with the third color light L3 and the fourth color light L4 to be located on both sides of the second color light L2 and travel together along the light-mixing axis M, thereby achieving the symmetric and uniform light-mixing effect.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multicolor light mixing module suitable for providing a multicolor laser beam to a laser projection device, the multicolor light mixing module comprising:
a laser source comprising at least two first lighting units, a second lighting unit, and a third lighting unit, the at least two first lighting units emitting a first color light toward a light-emitting direction, the second lighting unit emitting a second color light toward the light-emitting direction, and the third lighting unit emitting a third color light toward the light-emitting direction, wherein the at least two first lighting units, the second lighting unit, and the third lighting unit are sequentially arranged along an arrangement direction, and the arrangement direction is perpendicular to the light-emitting direction; and
a light-mixing unit disposed opposite to the laser source and having a first dichroic surface, a second dichroic surface, and a reflective surface, the first dichroic surface being oblique to reflect the first color light to travel along a light-mixing axis and to allow the second color light and the third color light to pass through and be incident onto the second dichroic surface, and the first dichroic surface, the second dichroic surface, and the reflective surface being sequentially arranged in parallel along a normal axis of the first dichroic surface, wherein the second dichroic surface allows the third color light to pass through and be incident onto the reflective surface and reflects the second color light to pass through the first dichroic surface and travel along the light-mixing axis, and the reflective surface reflects the third color light to sequentially pass through the second dichroic surface and the first dichroic surface and travel along the light-mixing axis, so that the first color light, the second color light, and the third color light are mixed along the light-mixing axis to form a multicolor laser beam.

2. The multicolor light mixing module of claim 1, wherein the light-mixing unit comprises a dichroic mirror and a reflective mirror, the dichroic mirror is oblique relative to the laser source, the first dichroic surface is formed at a light-entrance surface position of the dichroic mirror, the dichroic mirror and the reflective mirror are stacked and connected along the normal axis, the second dichroic surface is formed at a position where the dichroic mirror is connected to the reflective mirror, and the reflective surface is formed at a back surface position of the reflective mirror.

3. The multicolor light mixing module of claim 1, wherein the light-mixing unit comprises a dichroic mirror and a reflective mirror, the dichroic mirror is oblique relative to the laser source, the first dichroic surface is formed at a light-entrance surface position of the dichroic mirror, the second dichroic surface is formed at a back surface position of the dichroic mirror, the dichroic mirror and the reflective mirror are spaced apart from each other along the normal axis, and the reflective surface is formed at a light-entrance surface position of the reflective mirror.

4. The multicolor light mixing module of claim 1, wherein the light-mixing unit comprises a bottom corner prism, a middle prism, and a top edge prism, the bottom corner prism has the first dichroic surface, the bottom corner prism, the middle prism, and the top edge prism are sequentially spliced along the normal axis to cooperatively form a triangular prism column opposite to the laser source, the middle prism has the second dichroic surface, and the top edge prism has the reflective surface.

5. The multicolor light mixing module of claim 2, wherein the first color light is red light, the second color light is green light, and the third color light is blue light.

6. The multicolor light mixing module of claim 5, wherein a first optical path distance of the first color light incident on the first dichroic surface is shorter than a second optical path distance of the second color light passing through the first dichroic surface, being reflected by the second dichroic surface and being emitted from the first dichroic surface, and the second optical path distance is shorter than a third optical path distance of the third color light sequentially passing through the first dichroic surface and the second dichroic surface, being reflected by the reflective surface to pass through the second dichroic surface, and being emitted from the first dichroic surface.

7. The multicolor light mixing module of claim 1, wherein the laser source further comprises a fourth lighting unit, the fourth lighting unit is arranged adjacent to the third lighting unit along the arrangement direction and emits a fourth color light along the light-emitting direction, the fourth color light and the third color light are color lights of the same wavelength, the first dichroic surface allows the fourth color light to pass through and be incident onto the second dichroic surface, the second dichroic surface allows the fourth color light to pass through and be incident onto the reflective surface, and the reflective surface reflects the fourth color light to sequentially pass through the second dichroic surface and the first dichroic surface and travel along the light-mixing axis, so that the first color light, the second color light, the third color light, and the fourth color light are mixed along the light-mixing axis to form the multicolor laser beam.

8. The multicolor light mixing module of claim 7, wherein the light-mixing unit comprises a dichroic mirror and a reflective mirror, the dichroic mirror is oblique relative to the laser source, the first dichroic surface is formed at a light-entrance surface position of the dichroic mirror, the dichroic mirror and the reflective mirror are stacked and connected along the normal axis, the second dichroic surface is formed at a position where the dichroic mirror is connected to the reflective mirror, and the reflective surface is formed at a back surface position of the reflective mirror.

9. The multicolor light mixing module of claim 7, wherein the light-mixing unit comprises a dichroic mirror and a reflective mirror, the dichroic mirror is oblique relative to the laser source, the first dichroic surface is formed at a light-entrance surface position of the dichroic mirror, the second dichroic surface is formed at a back surface position of the dichroic mirror, the dichroic mirror and the reflective mirror are spaced apart from each other along the normal axis, and the reflective surface is formed at a light-entrance surface position of the reflective mirror.

10. The multicolor light mixing module of claim 7, wherein the light-mixing unit comprises a bottom corner prism, a middle prism, and a top edge prism, the bottom corner prism has the first dichroic surface, the bottom corner prism, the middle prism, and the top edge prism are sequentially spliced along the normal axis to cooperatively form a triangular prism column opposite to the laser source, the middle prism has the second dichroic surface, and the top edge prism has the reflective surface.

11. The multicolor light mixing module of claim 8, wherein the first color light is red light, the second color light is blue light, and the third color light and the fourth color light are green lights.

12. The multicolor light mixing module of claim 11, wherein a first optical path distance of the first color light incident on the first dichroic surface is shorter than a second optical path distance of the second color light passing through the first dichroic surface, being reflected by the second dichroic surface and being emitted from the first dichroic surface, the second optical path distance is shorter than a third optical path distance of the third color light sequentially passing through the first dichroic surface and the second dichroic surface, being reflected by the reflective surface to pass through the second dichroic surface, and being emitted from the first dichroic surface, and the second optical path distance is shorter than a fourth optical path distance of the fourth color light sequentially passing through the first dichroic surface and the second dichroic surface, being reflected by the reflective surface to pass through the second dichroic surface, and being emitted from the first dichroic surface.

13. The multicolor light mixing module of claim 1 further comprising:
at least one condensing lens disposed on the light-mixing axis for condensing the first color light, the second color light, and the third color light.

14. The multicolor light mixing module of claim 13, wherein the at least one condensing lens is a cylindrical lens.
